(19) United States
(12) Patent Application Publication
(10) Pub. No.: US 2021/0310386 A1
(43) Pub. Date: Oct. 7, 2021

(54) BLOWBY GAS ATMOSPHERE RELEASING DEVICE

(71) Applicant: ISUZU MOTORS LIMITED, Tokyo (JP)

(72) Inventor: Yuuki HIMURO, Fujisawa-shi, Kanagawa (JP)

(21) Appl. No.: 17/266,975

(22) PCT Filed: Aug. 2, 2019
(86) PCT No.: PCT/JP2019/030506

§ 371 Date: Feb. 8, 2021

(30) Foreign Application Priority Data
Aug. 8, 2018 (JP) 2018-149264

(51) Int. Cl. F01M 13/04

(52) U.S. Cl. CPC F01M 13/04

(57) ABSTRACT

There is provided a blowby gas atmosphere releasing device 20 for an engine 1 in which an intake flow path 3 is disposed at one side of an engine body 2 and an exhaust flow path 4 is disposed at the other side. The blowby gas atmosphere releasing device 20 includes an oil separator 22 that is connected to the engine body 2 and separates oil contained in blowby gas, and an atmosphere releasing pipe 23 that is connected to the oil separator 22 and is used to release the blowby gas to the atmosphere. The atmosphere releasing pipe 23 is disposed along the other side of the engine body 2.

### TECHNICAL FIELD

The present invention relates to a blowby gas atmosphere releasing device that releases blowby gas to the atmosphere.

### BACKGROUND ART

Blowby gas is generated when gas in a combustion chamber leaks into a crankcase and a cylinder head.

Therefore, an engine is provided with a mechanism for discharging the blowby gas from the crankcase and the cylinder head.

A positive crankcase ventilation system (PCV system) that returns blowby gas to an intake side and a blowby gas atmosphere releasing device that releases blowby gas to the atmosphere are generally known as such a mechanism.

### CITATION LIST

### Patent Literature

Patent Literature 1: JP-A-04-246217

Patent Literature 2: JP-A-2011-127490

Patent Literature 3: JP-A-2016-183604

Patent Literature 4: JP-A-2006-220057

### SUMMARY OF INVENTION

### Technical Problem

The blowby gas atmosphere releasing device has various advantages that the PCV system does not have.

For example, since the blowby gas atmosphere releasing device does not return blowby gas containing oil to the intake side, a compressor can be prevented from being contaminated by oil or the like in a turbo vehicle in particular. In addition, since the blowby gas atmosphere releasing device does not return blowby gas containing moisture to the intake side, the compressor can be prevented from being hit by frozen moisture that is cooled by intake air.

However, the blowby gas atmosphere releasing device has a matter that, in a low temperature environment, frost may occur on an inner surface of an atmosphere releasing pipe for releasing the blowby gas to the atmosphere, and the frost may grow gradually and may freeze to clog the atmosphere releasing pipe. Generally, the freezing tends to occur around an inner peripheral side of an outlet of the atmosphere releasing pipe and gradually grow to an upstream side.

The present invention is made in view of the above circumstance. An object of the present invention is to provide a blowby gas atmosphere releasing device that can prevent freezing of an atmosphere releasing pipe for releasing blowby gas to the atmosphere.

### Solution to Problem

According to one aspect of the present invention, there is provided a blowby gas atmosphere releasing device for an engine in which an intake flow path is disposed at one side of an engine body and an exhaust flow path is disposed at the other side. The blowby gas atmosphere releasing device includes an oil separator that is connected to the engine body and separates oil contained in blowby gas, and an atmosphere releasing pipe that is connected to the oil separator and is used to release the blowby gas to the atmosphere. The atmosphere releasing pipe is disposed along the other side of the engine body.

The atmosphere releasing pipe preferably includes a heat receiving pipe portion that receives heat from a heat source, and a heat insulating pipe portion having lower thermal conductivity than the heat receiving pipe portion.

Preferably, the oil separator is disposed at one side of the engine body, and the atmosphere releasing pipe from the oil separator to the other side of the engine body is implemented by the heat insulating pipe portion.

The heat receiving pipe portion is preferably made of a metal.

The heat insulating pipe portion is preferably made of an elastic resin.

A heat insulating material layer is preferably provided on an outer periphery of the heat insulating pipe portion.

### Advantageous Effects of Invention

According to the above aspect, freezing of the atmosphere releasing pipe for releasing the blowby gas to the atmosphere can be prevented.

### BRIEF DESCRIPTION OF DRAWINGS

FIG. 1 is a front view showing a blowby gas atmosphere releasing device according to an embodiment of the present invention.

FIG. 2 is a schematic top view showing an engine as viewed from above.

FIG. 3 is a cross-sectional view showing a heat insulating pipe portion.

FIG. 4 is a schematic view showing a state in which an atmosphere releasing pipe is cooled by outside air.

### DESCRIPTION OF EMBODIMENTS

Hereinafter, an embodiment of the present invention will be described with reference to the accompanying drawings. Front, rear, left, right, upper, and lower directions in the embodiment to be described below refer to directions of a vehicle.

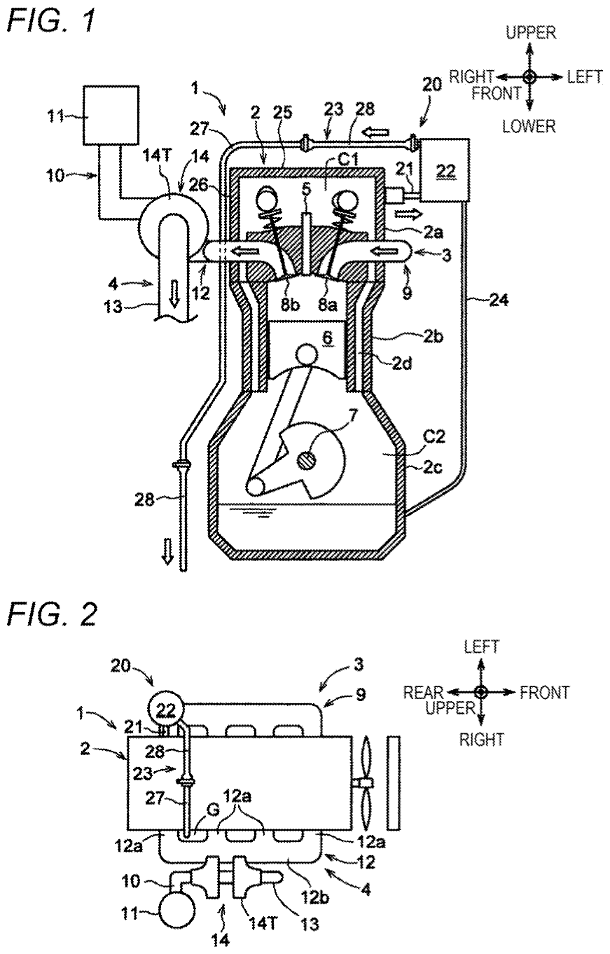

FIG. 1 is a front view showing a blowby gas atmosphere releasing device 20 according to the present invention as viewed from a front side. An engine (internal combustion engine) 1 is a multi-cylinder internal combustion engine of a compression ignition type mounted on the vehicle, that is, a diesel engine. Cylinders of the engine can be freely arranged and the number of the cylinders can be set to any number.

The engine 1 includes an engine body 2, an intake flow path 3 connected to the engine body 2, an exhaust low path 4 connected to the engine body 2, and a fuel injection device 5. The engine body 2 includes structural components such as a cylinder head 2a, a cylinder block 2b, and a crankcase 2c, and movable components such as a piston 6, a crankshaft 7, an intake valve 8a, and an exhaust valve 8b that are accommodated in the structural components. A space C1 in the cylinder head 2a and a space C2 in the crankcase 2c are connected by a gas flow path 2d formed in the cylinder block 2b.

The intake flow path 3 is disposed at one side (left side of the vehicle) of the engine body 2. The intake flow path 3 is mainly defined by an intake manifold 9 connected to the engine body 2 (particularly the cylinder head 2a) and an intake pipe 10 connected to an upstream end of the intake manifold 9. The intake manifold 9 distributes and supplies intake air sent from the intake pipe 10 to intake ports of the cylinders. The intake pipe 10 is provided with an air cleaner 11.

The exhaust flow path 4 is disposed at the other side (right side of the vehicle) of the engine body 2. The exhaust flow path 4 is mainly defined by an exhaust manifold 12 connected to the engine body 2 (particularly the cylinder head 2a) and an exhaust pipe 13 disposed downstream of the exhaust manifold 12.

As shown in FIG. 2, the exhaust manifold 12 includes a plurality of short pipe portions 12a connected to exhaust ports of the cylinders, and a collecting pipe portion 12b that is connected to the short pipe portions 12a and collects exhaust gas from the short pipe portions 12a. A gap G is formed between the short pipe portions 12a. As shown in FIGS. 1 and 2, a turbine 14T of a turbocharger 14 is disposed between the exhaust manifold 12 and the exhaust pipe 13. The exhaust pipe 13 downstream of the turbine 14T is provided with an exhaust purification device (not shown) using an oxidation catalyst, a particulate filter, a NOx catalyst, an ammonia oxidation catalyst, and the like.

The engine 1 includes the blowby gas atmosphere releasing device 20 that releases the blowby gas to the atmosphere.

The blowby gas atmosphere releasing device 20 includes an oil separator 22 connected to the space C1 in the cylinder head 2a via a connection pipe 21, and an atmosphere releasing pipe 23 that is connected to the oil separator 22 and is used to release the blowby gas to the atmosphere.

The oil separator 22 is a device that separates oil contained in the blowby gas. The oil separator 22 has a filter (not shown) therein. When the blowby gas passes through the filter, the oil separator 22 separates oil contained in the blowby gas. An oil return pipe 24 for returning the oil separated from the blowby gas to the engine body 2 is connected to the oil separator 22. The oil return pipe 24 is connected to the space C2 in the crankcase 2c.

The oil separator 22 is disposed at one side (intake side) of the engine body 2. Oil adheres to the oil separator 22. When the oil separator 22 is disposed at the other side (exhaust side) of the engine body 2, the oil separator 22 that receives radiant heat from the engine body 2 may be on fire. Therefore, the oil separator 22 is generally disposed at the intake side of the engine body 2. Specifically, the oil separator 22 is fixed in close proximity to an upper portion of the engine body 2 via a bracket or the like (not shown). The connection pipe 21 is formed to be short to an extent that heat radiation can be ignored. Accordingly, the blowby gas arriving at the oil separator 22 from the engine body 2 through the connection pipe 21 is prevented from being cooled before the blowby gas arrives at the oil separator 22.

The oil separator 22 is not limited to one having a filter. The oil separator 22 may include a blowby gas flow path (not shown) of a labyrinth type or may include a blowby gas flow path of another type. The oil separator 22 may be connected to the space C1 in the crankcase 2c via the connection pipe 21, or may be connected to the gas flow path 2d of the cylinder block 2b.

The atmosphere releasing pipe 23 is disposed along an upper face 25 of the engine body 2 and a side face 26 at the other side (exhaust side) of the engine body 2.

Further, the atmosphere releasing pipe 23 includes a heat receiving pipe portion 27 that receives heat from a heat source such as the engine body 2 or the exhaust flow path 4, and a heat insulating pipe portion 28 having lower thermal conductivity than the heat receiving pipe portion 27. The heat receiving pipe portion 27 is made of a metal pipe such as steel, copper, and aluminum. The heat insulating pipe portion 28 is made of an elastic resin.

The heat receiving pipe portion 27 is disposed in close proximity to the heat source in particular. Main heat sources in the present embodiment include the exhaust manifold 12, the exhaust pipe 13, and the engine body 2 that is close to the exhaust manifold 12. As shown in FIG. 2, the heat receiving pipe portion 27 is disposed along the side face 26 at the other side (exhaust side) of the engine body 2, and is vertically inserted through the gap G between the short pipe portions 12a. Accordingly, the heat receiving pipe portion 27 actively receives heat from the heat source.

The heat receiving pipe portion 27 is not only applied to a portion close to a heat source but also applied to a high temperature portion. Here, the high temperature portion refers to a portion of the atmosphere releasing pipe 23 where a temperature of the atmosphere releasing pipe 23 exceeds a heat resistance temperature of the heat insulating pipe portion 28. As shown in FIG. 4, when the vehicle travels, the atmosphere releasing pipe 23 radiates heat while receiving heat from a heat source. A heat radiation amount varies depending on a flow rate of traveling wind received by the atmosphere releasing pipe 23, a temperature, and the like, and the heat radiation amount is not constant. A radiant heat amount from a heat source varies depending on an operating state of the engine (particularly a fuel injection amount) and the like, and the radiant heat amount is not constant. Therefore, whether there is a high temperature portion is examined by performing an experiment, a simulation, and the like in advance.

For example, in the present embodiment, the high temperature portion is a portion of the atmosphere releasing pipe 23 that is located at the right side (exhaust side) from the center in a left-right direction of the engine body 2 and is located above a center height of the crankshaft 7. Such a high temperature portion includes the heat receiving pipe portion 27.

The heat insulating pipe portion 28 is applied to a portion other than the high temperature portion. That is, the heat insulating pipe portion 28 is applied to a portion of the atmosphere releasing pipe 23 at the left side (intake side) from the center in the left-right direction of the engine body 2 and a portion below the center height of the crankshaft 7. The heat insulating pipe portion 28 is made of a material of which thermal conductivity is lower than that of the heat receiving pipe portion 27 and on which frost is unlikely to freeze. Specifically, the heat insulating pipe portion 28 is implemented by a rubber hose. Therefore, even when the heat insulating pipe portion 28 receives low temperature traveling wind, heat radiation from the heat insulating pipe portion 28 can be prevented, and frost in the heat insulating pipe portion 28 can be prevented from freezing.

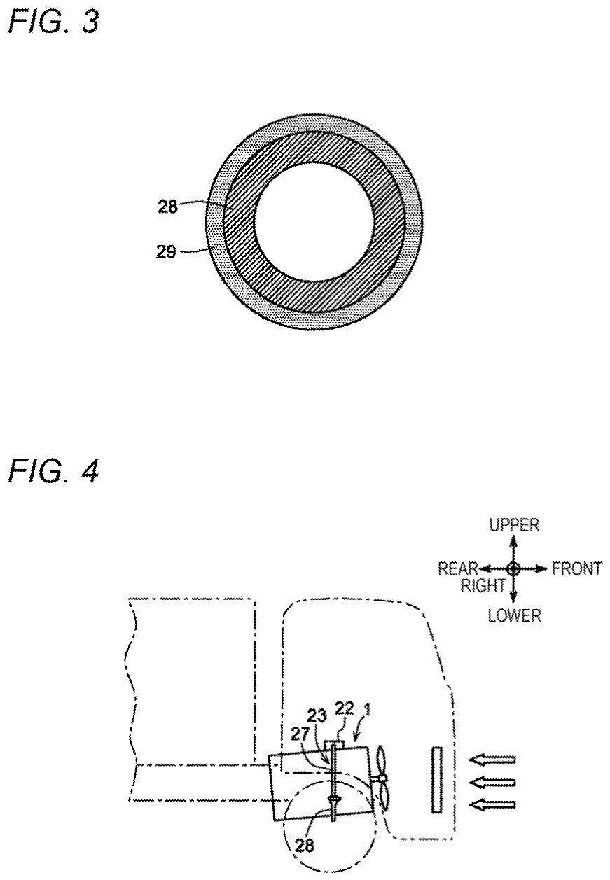

As shown in FIG. 3, a heat insulating material layer 29 is disposed on an outer periphery of the heat insulating pipe portion 28. Specifically, the heat insulating material layer 29 is made of a foamed resin having heat resistance and flame retardancy. The foamed resin is made of, for example, ethylene propylene rubber (EPDM). The heat insulating material layer 29 is formed by spirally winding a tape-shaped foamed resin around the outer periphery of the heat insulating pipe portion 28.

The heat insulating material layer 29 is not limited thereto. For example, the heat insulating material layer 29 may be formed by spraying and coating a foamy resin onto the outer periphery of the heat insulating pipe portion 28. A heat insulating material is not limited to EPDM. The heat insulating material may be another type of material having excellent heat insulation, heat resistance, and flame retardancy.

Next, effects of the present embodiment will be described.

When the engine 1 is operated, an air-fuel mixture or post-combustion gas in the combustion chamber leaks into the space C2 of the crankcase 2c or the space C1 of the cylinder head 2a from a gap or the like between the piston 6 and the cylinder block 2b, and blowby gas is generated. At this time, the atmosphere releasing pipe 23 releases the blowby gas to the atmosphere, and the connection pipe 21 communicates with the atmosphere releasing pipe 23 via the oil separator 22. Therefore, the blowby gas in the spaces C1 and C2 of the crankcase 2c and the cylinder head 2a flows through the connection pipe 21, the oil separator 22, and the atmosphere releasing pipe 23 in this order, and the blowby gas is released to the atmosphere from the atmosphere releasing pipe 23. At this time, the blowby gas passes through the filter in the oil separator 22. As a result, oil contained in the blowby gas is collected by the filter and is separated from the blowby gas. The oil separated from the blowby gas is returned into the crankcase 2c via the oil return pipe 24.

When the engine 1 is operated, high temperature exhaust gas flows through the exhaust manifold 12, the turbine 14T, and the exhaust pipe 13 in this order, and is discharged through the exhaust purification device. As a result, temperatures of the engine body 2, the exhaust manifold 12, the turbine 14T, and the exhaust pipe 13 are increased, and radiant heat is generated. A part of the radiant heat heats the atmosphere releasing pipe 23. Accordingly, the blowby gas in the atmosphere releasing pipe 23 is warmed. In particular, the heat receiving pipe portion 27 is made of a metal having high thermal conductivity. Therefore, a temperature of the blowby gas passing through the heat receiving pipe portion 27 is efficiently increased.

The heat insulating pipe portion 28 of the atmosphere releasing pipe 23 is made of a resin having low thermal conductivity. Therefore, heat radiation from the heat insulating pipe portion 28 is prevented and a temperature of the blowby gas in the heat insulating pipe portion 28 is prevented from being reduced.

For example, when the vehicle travels in a low temperature environment, low temperature traveling wind hits the atmosphere releasing pipe 23. The atmosphere releasing pipe 23 from the oil separator 22 to the other side (exhaust side) of the engine 1 does not really receive radiant heat. Therefore, the blowby gas tends to be cooled when flowing from the oil separator 22 to the other side of the engine 1. However, the atmosphere releasing pipe 23 from the oil separator 22 to the other side of the engine 1 is implemented by the heat insulating pipe portion 28. Therefore, the temperature of the blowby gas is prevented from being reduced, and frost in the heat insulating pipe portion 28 is prevented from freezing and growing. The blowby gas arriving at the other side of the engine body 2 is heated by radiant heat from the heat source. At this time, the atmosphere releasing pipe 23 disposed above the engine body 2 and at the other side of the engine body 2 is implemented by the heat receiving pipe portion 27. Therefore, the radiant heat is efficiently transferred from an outer peripheral surface to an inner peripheral surface of the heat receiving pipe portion 27, and the temperature of the blowby gas is efficiently increased. Thereafter, when the blowby gas passes through the heat receiving pipe portion 27 close to the exhaust manifold 12, the temperature of the blowby gas is further increased, and then the blowby gas flows to the heat insulating pipe portion 28 below the exhaust manifold 12. The heat insulating pipe portion 28 does not really receive radiant heat. Therefore, the blowby gas tends to be cooled again. However, the thermal conductivity of the heat insulating pipe portion 28 is low, and the temperature of the blowby gas is increased in advance by the heat receiving pipe portion 27. Therefore, the blowby gas is maintained at a relatively high temperature up to an outlet of the atmosphere releasing pipe 23, and freezing inside the atmosphere releasing pipe 23 is prevented.

As described above, the atmosphere releasing pipe 23 is disposed along the exhaust side of the engine body 2. Therefore, the temperature of the blowby gas in the atmosphere releasing pipe 23 can be increased by radiant heat from the engine body 2, and freezing inside the atmosphere releasing pipe 23 can be prevented.

The atmosphere releasing pipe 23 includes the heat receiving pipe portion 27 that receives heat from the heat source and the heat insulating pipe portion 28 having lower thermal conductivity than the heat receiving pipe portion 27. The atmosphere releasing pipe 23 close to the exhaust flow path 4 is implemented by the heat receiving pipe portion 27. Therefore, the temperature of the blowby gas in the heat receiving pipe portion 27 can be increased by radiant heat from the exhaust flow path 4 and the engine body 2 close to the exhaust flow path 4. Then, freezing inside the atmosphere releasing pipe 23 downstream of the heat receiving pipe portion 27 can be prevented.

The atmosphere releasing pipe 23 from the oil separator 22 to the other side of the engine body 2 is implemented by the heat insulating pipe portion 28. Therefore, heat radiation from the atmosphere releasing pipe 23 located from the oil separator 22 to the other side of the engine body 2 can be prevented.

Since the heat receiving pipe portion 27 is made of a metal pipe, the radiant heat from the heat source can be efficiently transferred to the blowby gas, and the heat receiving pipe portion 27 can be formed at a low cost.

Since the heat insulating pipe portion 28 is made of an elastic resin pipe, the temperature of the blowby gas can be prevented from being reduced, and the heat insulating pipe portion 28 can be easily formed and can be formed at a low cost.

Since the heat insulating material layer 29 is disposed on the outer periphery of the heat insulating pipe portion 28, heat radiation from the heat insulating pipe portion 28 can be further prevented.

Although the embodiment of the present invention has been described in detail above, the present invention may also have other embodiments as follows.

For example, the heat receiving pipe portion 27 is disposed between the short pipe portions 12a of the exhaust manifold 12 in the present embodiment. Alternatively, the heat receiving pipe portion 27 may be disposed between the exhaust manifold 12 and the turbine 14T.

Configurations of embodiments described above can be partially or entirely combined as long as there is no contradiction. The embodiments of the present invention are not limited to the embodiments described above, and all modifications, applications, and equivalents that fall within the spirit of the present invention as defined by the claims are included in the present invention. Accordingly, the present invention should not be construed as being limited, and can be applied to any other technique belonging to the scope of the spirit of the present invention.

The present application is based on Japanese Patent Application (No. 2018-149264) filed on Aug. 8, 2018, contents of which are incorporated herein as reference.

### INDUSTRIAL APPLICABILITY

According to the present invention, freezing of the atmosphere releasing pipe for releasing the blowby gas to the atmosphere is prevented. Heat radiation from the atmosphere releasing pipe located from the oil separator to the other side of the engine body is prevented. Since the heat receiving pipe portion is made of a metal pipe, radiant heat from the heat source is efficiently transferred to the blowby gas, and the heat receiving pipe portion is formed at a low cost. Since the heat insulating pipe portion is made of an elastic resin pipe, the temperature of the blowby gas is prevented from being reduced, and the heat insulating pipe portion is easily formed and is formed at a low cost. In addition, since the heat insulating material layer is provided on the outer periphery of the heat insulating pipe portion, heat radiation from the heat insulating pipe portion is further prevented.

### REFERENCE SIGNS LIST

1 engine
2 engine body
2a cylinder head
2b cylinder block
2c crankcase
2d gas flow path
3 intake flow path
4 exhaust flow path
5 fuel injection device
6 piston
7 crankshaft
8a intake valve
8b exhaust valve
9 intake manifold
10 intake pipe
11 air cleaner
12 exhaust manifold
12a short pipe portion
12b collecting pipe portion
13 exhaust pipe
14 turbocharger
14T turbine
20 blowby gas atmosphere releasing device
21 connection pipe
22 oil separator
23 atmosphere releasing pipe
24 oil return pipe
25 upper face
26 side face
27 heat receiving pipe portion
28 heat insulating pipe portion
29 heat insulating material layer
C1 space
C2 space
G gap

1. A blowby gas atmosphere releasing device for an engine in which an intake flow path is disposed at one side of an engine body and an exhaust flow path is disposed at the other side, the blowby gas atmosphere releasing device comprising:
an oil separator that is connected to the engine body and separates oil contained in blowby gas;
an atmosphere releasing pipe that is connected to the oil separator and releases the blowby gas to the atmosphere,
wherein the atmosphere releasing pipe is disposed along the other side of the engine body.

2. The blowby gas atmosphere releasing device according to claim 1,
wherein the atmosphere releasing pipe includes a heat receiving pipe portion that receives heat from a heat source and a heat insulating pipe portion having lower thermal conductivity than the heat receiving pipe portion.

3. The blowby gas atmosphere releasing device according to claim 2,
wherein the oil separator is disposed at one side of the engine body, and
wherein the atmosphere releasing pipe from the oil separator to the other side of the engine body is implemented by the heat insulating pipe portion.

4. The blowby gas atmosphere releasing device according to claim 2,
wherein the heat receiving pipe portion is made of a metal.

5. The blowby gas atmosphere releasing device according claim 2,
wherein the heat insulating pipe portion is made of an elastic resin.

6. The blowby gas atmosphere releasing device according to claim 2,
wherein a heat insulating material layer is provided on an outer periphery of the heat insulating pipe portion.
